(19) United States
(12) Patent Application Publication
(10) Pub. No.: US 2017/0085964 A1
(43) Pub. Date: Mar. 23, 2017

(54) Interactive Object Placement in Virtual Reality Videos

(71) Applicant: Lens Entertainment PTY. LTD., Wollstonecraft (AU)

(72) Inventor: Yan Chen, Wollstonecraft (AU)

(21) Appl. No.: 15/258,344

(22) Filed: Sep. 7, 2016

Related U.S. Application Data
(60) Provisional application No. 62/220,217, filed on Sep. 17, 2015.

(51) Int. Cl. H04N 21/81; H04N 21/433; H04N 21/4143; G06T 19/00; H04N 21/442

(52) U.S. Cl. CPC H04N 21/816; G06T 19/006; H04N 21/8146; H04N 21/44218; H04N 21/812; H04N 21/4143; H04N 21/433

(57) ABSTRACT

A method for processing a virtual reality video (“VRV”) by a virtual reality (“VR”) computing device comprises identifying objects in the VRV for interactive product placement, generating interactive objects for the VRV based on the identified objects, embedding the VRV with the generated interactive objects, and storing the embedded VRV. Creation of interactive product placements is provided in a monoscopic or stereoscopic virtual reality video. Users' gaze directions are recorded and analyzed via heat maps to further inform and refine creation of interactive content for the virtual reality video.

### CROSS REFERENCE

This application claims priority from a provisional patent application entitled “Interactive Product Placement in Virtual Reality Videos” filed on Sep. 17, 2015 and having application No. 62/220,217. Said application is incorporated herein by reference.

### FIELD OF INVENTION

The disclosure relates to processing a virtual reality video (“VRV”), and, more particularly, to a method, a device, and a system for processing the VRV to embed interactive objects in the VRV.

### BACKGROUND

Virtual reality (“VR”) is a new field that allows for unprecedented levels of immersion and interaction with a digital world. While there has been extensive development on three-dimensional (“3D”) interactivity within a 3D VR environment for educational and entertainment purposes, currently, there is no method, device, or system for content makers to embed their interactive contents in a VRV. By extension, there is also no method, device, or system for a target audience to interact with such content. In advertising, it is recognized that targeted interactions are the best way to reach an audience.

While attempts at interactivity have been tried in a flat television screen presentation with two-dimensional (“2D”) interactive elements, fully immersive 3D interactions have not been possible using a 3D based system or augmented reality system. Therefore, it is desirable to provide new methods, devices, and systems for processing virtual reality video to embed interactive 3D objects in the content of the VRV.

### SUMMARY OF INVENTION

Briefly, the disclosure relates to a method for processing a virtual reality video (“VRV”) by a virtual reality (“VR”) computing device, comprising the steps of: identifying objects for embedding in the VRV for interactive product placement; generating interactive objects for the VRV; embedding the VRV with the generated interactive objects by the VR computing device; and storing the embedded VRV in a data storage by the VR computing device.

### DESCRIPTION OF THE DRAWINGS

The foregoing and other aspects of the disclosure can be better understood from the following detailed description of the embodiments when taken in conjunction with the accompanying drawings.

FIG. 1 illustrates a flow chart of the present disclosure for embedding interactive objects in a virtual reality video.

FIG. 2 illustrates a diagram of a virtual reality system of the present disclosure for embedding interactive objects in a virtual reality video and distributing that embedded virtual reality video.

FIG. 3 illustrates a high level process flow diagram of the present disclosure for interactive product placement (“IPP”).

FIG. 4 illustrates a process flow diagram of the present disclosure for the generation of IPP content.

FIG. 5 illustrates a drawing of a single-eye view of a frame for a virtual reality video (“VRV”) having masked objects to identify IPP of the present disclosure.

FIG. 6 illustrates a process flow diagram of the present disclosure for presentation of IPP content to an end user.

FIGS. 7a-7b illustrate diagrams for determining 3D depth value(s) of masked IPP objects of the present disclosure.

FIG. 8 illustrates a drawing of a single-eye view of a frame for a VRV having IPP markers.

FIG. 9 illustrates a process flow diagram of the present disclosure for user interaction with IPP.

FIG. 10 illustrates a process flow diagram of the present disclosure for generating a user gaze based heat map.

FIG. 11 illustrates a drawing of a heat map.

FIG. 12 illustrates a drawing of a heat map with areas of interest.

FIG. 13 illustrates a process flow diagram of the present disclosure for aggregating and analyzing a heat map.

FIG. 14 illustrates a drawing of a result from a heat map analysis of a single-eye view of a frame for a VRV.

### DETAILED DESCRIPTION OF THE EMBODIMENTS

In the following detailed description of the embodiments, reference is made to the accompanying drawings, which form a part hereof, and in which is shown by way of illustration of specific embodiments in which the disclosure may be practiced.

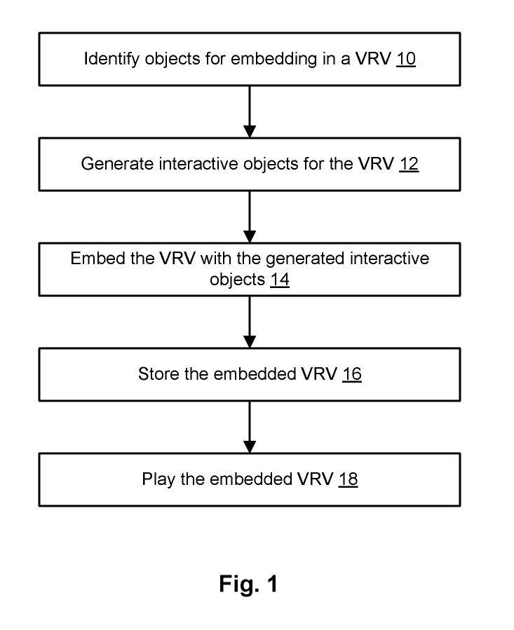

FIG. 1 illustrates a flow chart of the present disclosure for embedding interactive objects in a virtual reality video. A virtual reality video (“VRV”) can be processed by identifying one or more interactive objects for embedding into the VRV, step 10. The objects can be present in the video content of the VRV or be created for placement into the video content of the VRV. The selected objects are generated and/or set up for interactivity, step 12. It is appreciated that a virtual reality video can include virtual content, augmented reality content, recorded content, and any other content that can be played by a virtual reality player. To aid in the understanding of the present disclosure, a VRV of the present disclosure is meant to include all these various variations of video content.

Each object can have metadata to define the interactivity of the respective object with a user. The metadata can include an object identifier for identifying the respective object, a content provider identifier for identifying the content provider of the respective object, an interaction type for defining the type of interaction the respective object is capable of, active frames for defining which frames have the respective object in the VRV, web links for linking the respective object to the listed web links, image links for linking the respective object to the image links, video links for linking the respective object to the video links, price point for listing a particular price of a product being sold via the respective object, a payment gateway for linking the user to a payment interface for buying a product being sold via the respective objects, an object color for highlighting the respective object in a specific color, object data for listing any particular data for the respective object, text for the respective object when selected, and other fields as needed or designed. It is understood by a person having ordinary skill in the art that the metadata fields can be defined with additional metadata fields, with a subset of the ones defined above, or with some combination thereof.

The generated interactive objects can then be embedded in the VRV, step 14. In order to do so, the metadata can be packaged into the data of the VRV. When a user decides to watch the embedded VRV, the user can play the content of the embedded VRV and be provided the ability to interact with the interactive objects in the embedded VRV. The metadata fields for each interactive object define the type of interaction with a user (e.g., how the user can interact with the interactive object), whether it be viewing a website with the interactive object being sold or simply having the option to purchase a physical product that the virtual interactive object represents.

The embedded VRV can be stored in a data storage, step 16. The data storage can be a locally connected hard drive, a cloud storage, or other type of data storage. When a user views the embedded VRV, the user can download the VRV or stream the embedded VRV from the hard drive or cloud storage.

Once the VRV is downloaded (or initiation of the VRV stream has begun), the embedded VRV can be played by a VR player, step 18, an optional step. VR players are becoming more and more ubiquitous and can be found in many homes today, including VR headsets such as HTC Vive, Oculus Rift, Sony PlayStation VR, Samsung Gear VR, Microsoft HoloLens, and so on. VR players can include other devices and systems, not named above, that are capable of playing virtual reality content. It is appreciated by a person having ordinary skill in the art that other VR players can be used in conjunction with the present disclosure.

The steps involved in the present disclosure can be combined or further separated into individual steps. The flow chart diagram illustrated in FIG. 1 is one example of the present disclosure in which interactive product placement can be processed into a VRV. It is understood that other variations based on the present disclosure can be envisioned.

Generally, the present disclosure provides varying flow charts for identifying various objects or regions within a VRV to embed interactivity and/or to generate and embed virtual objects within the regions of interest. Based on the selection of such interactive object, a user can be presented with one or more various interactions types for that respective object. For instance, in one interaction, the user can be presented with text and images forming an advertisement of the interactive object. Furthermore, the user can access a webpage during the interaction to buy the real world object associated with the interactive object. The applicability of such technology can be numerous in terms of the type of products that can be selected for interactivity and the types of interactivity.

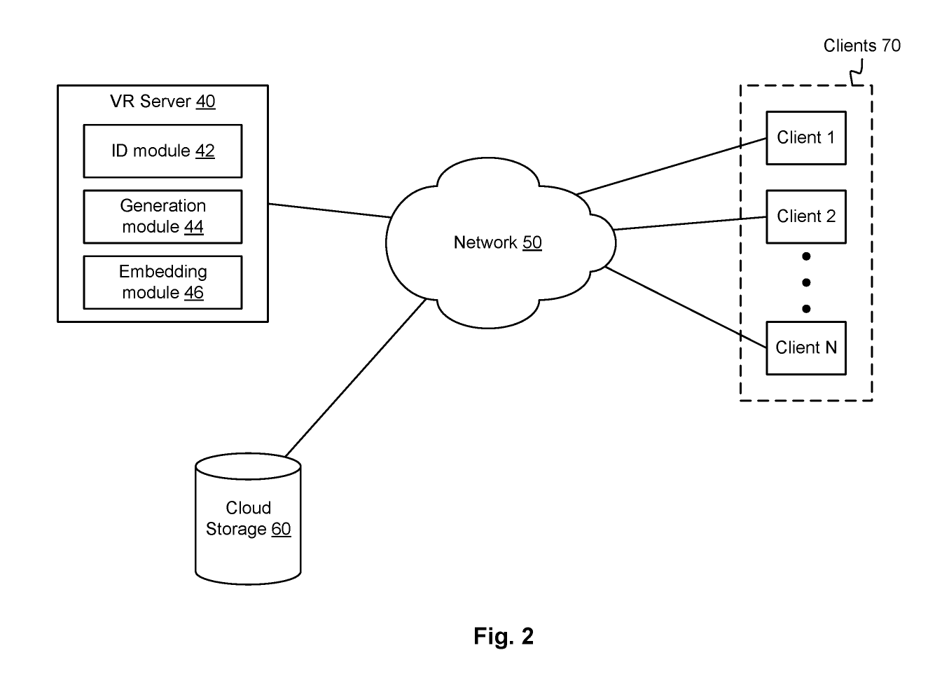

FIG. 2 illustrates a diagram of a virtual reality system of the present disclosure for embedding interactive objects in a virtual reality video and distributing that embedded virtual reality video. A VR server 40 can be connected via a network 50 to a cloud storage 60 and to clients 70. The VR server 40 comprises an identification (“ID”) module 42 for identifying objects in a VRV or regions for objects in the VRV, a generation module 44 for generating interactive objects out of the identified objects or the identified regions, and an embedding module 46 for embedding the VRV with the generated objects. The VR server 40 can also comprise one or more standard components including a central processing unit, random access memory, a motherboard, network interface module, a data storage, and other standard components that are not shown, but are generally known in the art.

A VR server 40 is an example of a VR computing device for processing the virtual reality video for interactive product placement. It is appreciated that other VR computing devices having modules 42, 44, and 46 can be used to process the virtual reality video, including a laptop computer, a desktop computer, a tablet, a smart phone, and any other computing device.

The VR server 40 can request a VRV from the cloud storage 60 and process the received VRV by determining interactive objects to generate and embed in the VRV. Next, the VRV is processed by the VR server 40 for embedding of the generated interactive objects. The embedded VRV can then be stored locally on the server 40 and/or stored back to the cloud storage 60 for further streaming to the clients 70.

One or more of the clients 70 can access the cloud storage 60 for playing of the embedded VRV. The clients 1-N can be VR players connected to the network 50, where the network 50 can be a local network or the internet. From there, the clients 1-N can play the embedded VRV. Upon interaction by one of the clients with an embedded interactive object in the VRV, an interaction can be initiated based on the programmed metadata for that selected interactive object.

For instance, suppose a bottle of wine is an interactive object within a scene of the VRV. The metadata for that bottle of wine can be programmed with a website linking the user of the VR player to the seller of that bottle of wine and/or to reviews for that bottle of wine. Furthermore, another web link can follow during the interaction in which the user can select a physical bottle of wine for purchase. Thus, the interactive objects within the IPP can be used for targeted interactive product placement in the VRV. The products can be placed by a content provider for a particular VRV. Here, the winery that produces the interactive wine bottle can contact the content provider for advertising its wine in the VRV. The content provider can place targeted advertisements for the winery's wines in the VRV as an interactive product. The process for identifying and embedding IPP in the VRV can also be automated such that specific interactive objects can be placed in the VRV based on a predetermined set of factors for placement. Other objects within the VRV can also be used for targeted product placement depending on whether other content providers decide to advertise their wares in the VRV or if an automated interactive object placement is triggered.

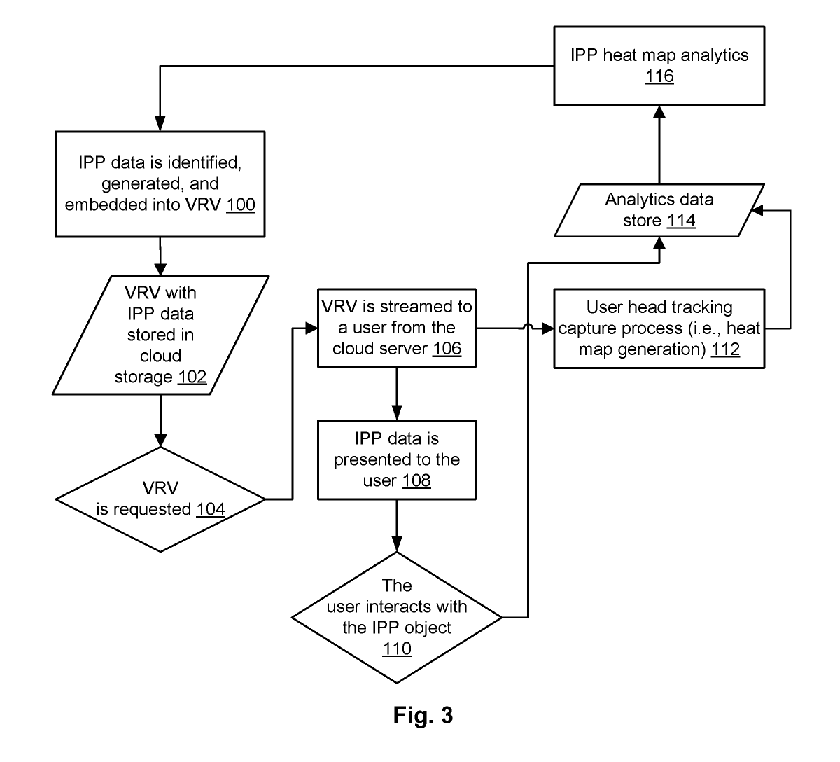

FIG. 3 illustrates a high level process flow diagram of the present disclosure for interactive product placement (“IPP”). In an embodiment of the present disclosure, heat map analytics can be used to further refine subsequent iterations of IPP for a VRV. When a content maker (e.g., an advertiser, educator, entertainer, and more) wants to generate an object in the VRV for 3D interaction, the content maker can perform the following steps. First, the content maker can generate the IPP metadata by identifying and tagging the objects they want to make available for interaction, step 100. Second, the content maker can embed the data into the video stream for distribution and associate the video data with the IPP metadata. Such embedded data for the VRV 102 is stored in the cloud storage for streaming to a requesting user for playback. If the VRV is requested, step 104, the embedded VRV is streamed to the end user as part of a standard VRV internet streaming workflow, step 106.

When objects tagged for IPP are in the view of the user, markers will indicate that they can be interacted with, step 108. Should the user choose to interact with the IPP, step 110, a set of interaction templates describes the form of that interaction. It is up to the VRV client platform to make such interactions possible. Concurrent to the user watching the video, data analytics about where the user is looking in the video during the interaction through head tracking (or other tracking mechanisms) can be gathered as analytics data 114. The analytics data 114 can be sent to an analytics database for further evaluation. Other data gathered from the user's interaction can also be used for the analytics data store 114.

An IPP heat map analytics is performed on the analytics data, step 116, to further inform the IPP content makers if any changes are needed in future iterations of the IPP, e.g., if the advertisements need to be more targeted, be placed in more ideal locations, carry the correct importance value, such as pricing guidelines for advertising space, and/or to make other decisions based on the analytics data store. With this information, further IPP data creation or refinement can be identified, generated, and embedded in the VRV starting at step 100 in an iterative loop.

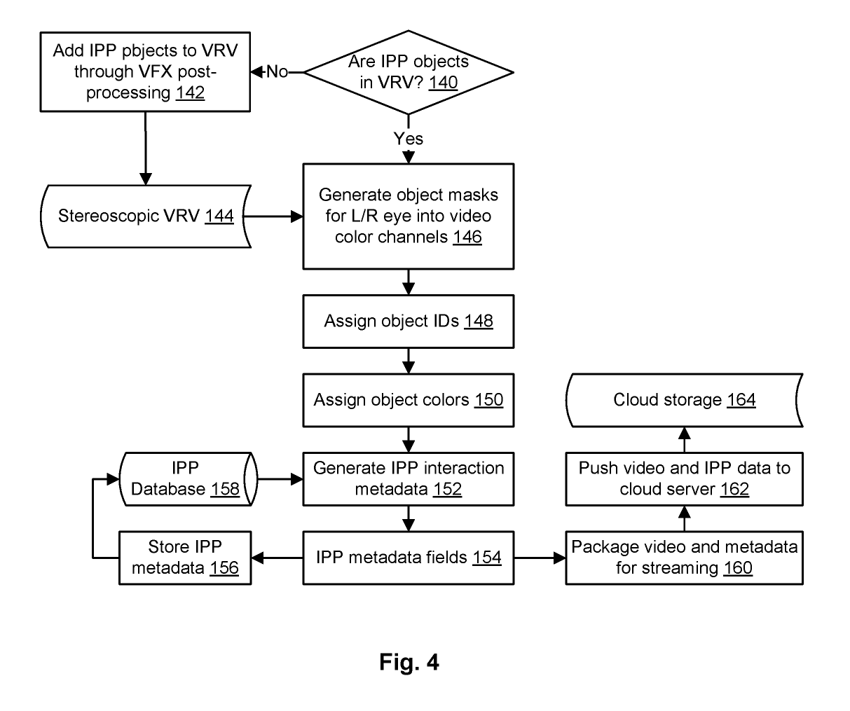

FIG. 4 illustrates a process flow diagram of the present disclosure for the generation of IPP content. The IPP content generation process starts with the determination if IPP objects are in the VRV, step 140. If the objects are not in the VRV, the objects need to be added into the VRV through visual effects post processing so that the objects look like they belong naturally in the scene and appear at the correct locations and times in the VRV, step 142. The source and resultant VRV should have both left-eye and right-eye views for the objects.

The object masks for the left and right eyes are generated for the video color channels of the VRV, step 146, and applied to the stereoscopic VRV 144. When the objects are placed in the scene, they need to be tagged and masked for the duration of the frames that the user interaction is allowed for the objects. The masking can be generated through standard object masking processes in a standard video post processing workflow. There needs to be separate masks for each of the left-eye and the right-eye views, where the masks for each view occupy the same frame range in the VRV for the same objects. Once the masks are generated, each of the objects is assigned a unique object ID for the duration of the VRV, step 148, and a unique color value for the duration of the shot, step 150.

Next, the IPP interaction metadata is generated, step 152. The IPP metadata fields can be defined in accordance with the IPP interaction, step 154. The IPP metadata fields can then be stored, step 156, in an IPP database 158. The IPP database 158 can be updated by forwarding metadata to the generation of the IPP interaction in step 152. Once the metadata fields are programmed, the video and metadata can be packaged for streaming 160. The packaged video can then be pushed to a cloud server, step 162, and eventually stored in a cloud storage 164. It is apparent to a person having ordinary skill in the art that other storage means can be used for storing of the packaged VRV. To aid in the understanding of the invention, a cloud storage example is given, but it is understood that other types of data storage devices can be used for storing of the packaged video.

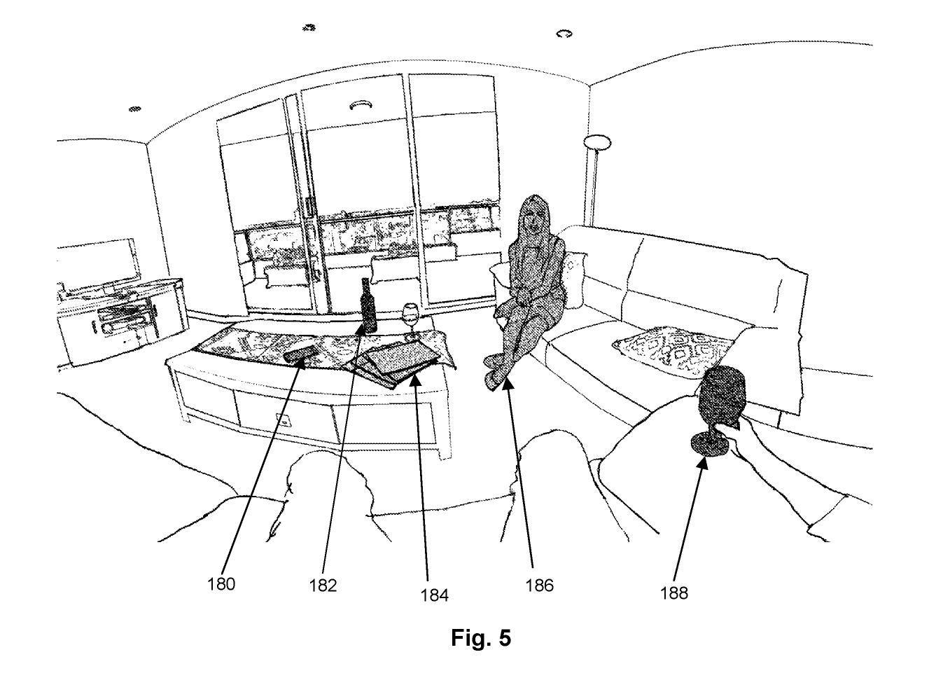

FIG. 5 illustrates a drawing of a single-eye view of a frame for a virtual reality video having masked objects to identify the IPP. A shot from a VRV can be defined as a set of contiguous frames where the camera source location is continuous from one frame to the next frame. There can be five objects 180-188 masked out in the frame with unique identifiers (“IDs”) and color values. In an example encoding for the VRV, an 8-bit per color channel can be employed for the VRV, providing for two hundred fifty-six objects masked out per frame. Due to loss of quality in video compression, it is necessary to use fewer values. A separation of eight integer points can be enough to ensure uniqueness after video compression, resulting in the ability to mask up to thirty-two IPP objects per shot.

Referring to FIG. 5, the objects 180-188 can have a separation of fifty-one by having the following color values, 205, 154, 103, 52, and 1, respectively. These masks can then be packaged for delivery to end users through a standard video encoding and encryption workflow into its own video channel. The commonly used alpha channel or a separate RGB stream can be used for this purpose. This video channel can then be packaged to be delivered to the client as standard video content.

After the masks are generated and encoded alongside the VRV, at which point, there will be left and right pairs of masks for each IPP object, there needs to be corresponding metadata for each IPP object. The metadata fields include the unique object ID, unique object color in that shot, content partner ID (identifying the generator of this IPP), and the interaction template type along with all the necessary interaction metadata. At a minimum, the necessary interaction metadata can include text for that interaction, active frames, any relevant web links to be presented, image links, video links, any purchase sales prices along with tax rates, and any necessary payment gateway information. The 2D/3D object data can also be included in the metadata to allow for further rendering of interactive graphics. This metadata can be stored in an IPP database to be catalogued, referenced, and/or re-used.

At the same time, this metadata is also packaged alongside the VRV stream for delivering to end users. The encoding and storage of this metadata for serving to clients can take the form of any commonly used and encrypt-able web formats, such as JSON or XML. Once the VRV with the encoded IPP masks and the IPP metadata are packaged and stored, they are made ready for streaming to end users via a cloud server or other mechanism.

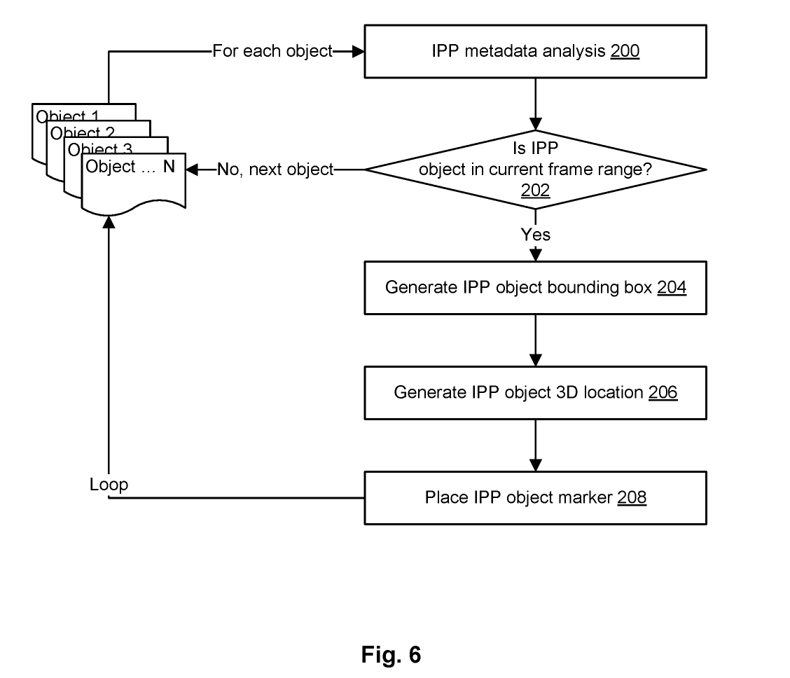

FIG. 6 illustrates a process flow diagram of the present disclosure for presentation of IPP content to end users. From an end user's perspective, his/her consumption of IPP content starts with the viewing of a VRV that has been set up to deliver IPP. The metadata for IPPs within that VRV is analyzed and filtered, step 200; thereby building up a list of IPPs for a given shot. Next, it's determined if an IPP object is in the current shot's frame range, step 202. If so, a bounding box is generated in the video texture space for the shot, step 204, based on the color mask for that object. The object's location in space relative to the camera's coordinate's system can be determined for each eye, step 206. In addition to the object's location, its depth value can be determined based on the disparity of its bounding box center positions in each eye. The IPP object marker can then be placed, step 208.

After the IPP object marker is placed in step 208, any next object is processed in a loop by starting at analyzing the IPP metadata of the next object, step 200. If the IPP object is not in the current frame range in step 202, the next object is processed in a loop by also analyzing the IPP metadata of the next object in step 200.

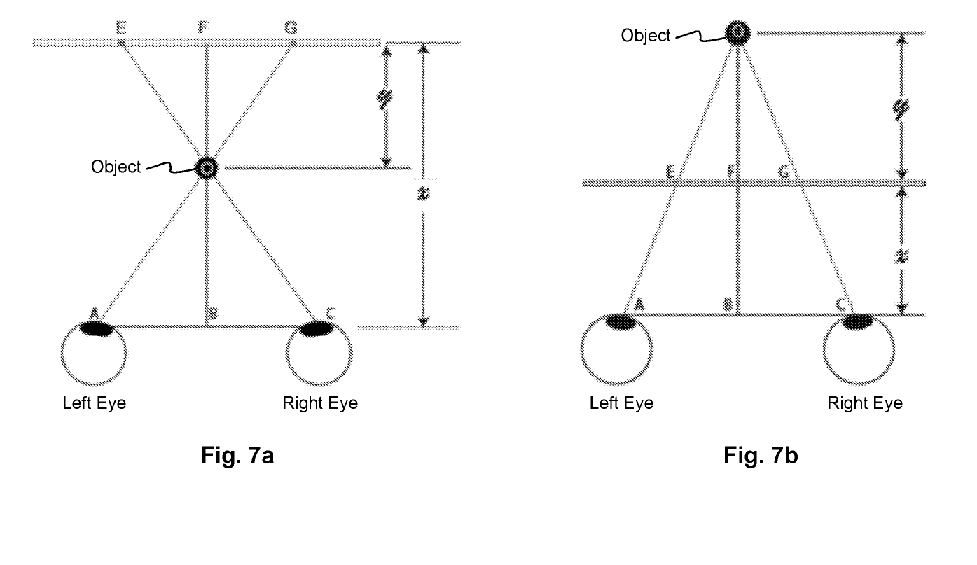

FIG. 7 illustrates a drawing of how to determine 3D depth value(s) of masked IPP objects of the present disclosure. To calculate an object's depth, or distance from a camera, one must know the cameras' intraocular distance AC and if the camera were parallel or toe-in pairs. This data can determine the distance of a zero parallax plane EFG. The distance of the object to the zero parallax plane EFG and therefore the distance to a camera plane ABC can be easily determined based on the equations below and diagrams referred to in FIGS. 7a-7b. For instance, when the object is in front of the zero parallax plane EFG, then

y=EG/(AC+EG)*x. Eq. 1

When the object is behind the zero parallax plane EFG, then

y=EG/(AC−EG)*x. Eq. 2

When the object is at the zero parallax plane EFG, then EG=0 and y=0. Once the distances are known, the Cartesian coordinates for the object's center are also known in a 3D space relative to the camera's viewpoint.

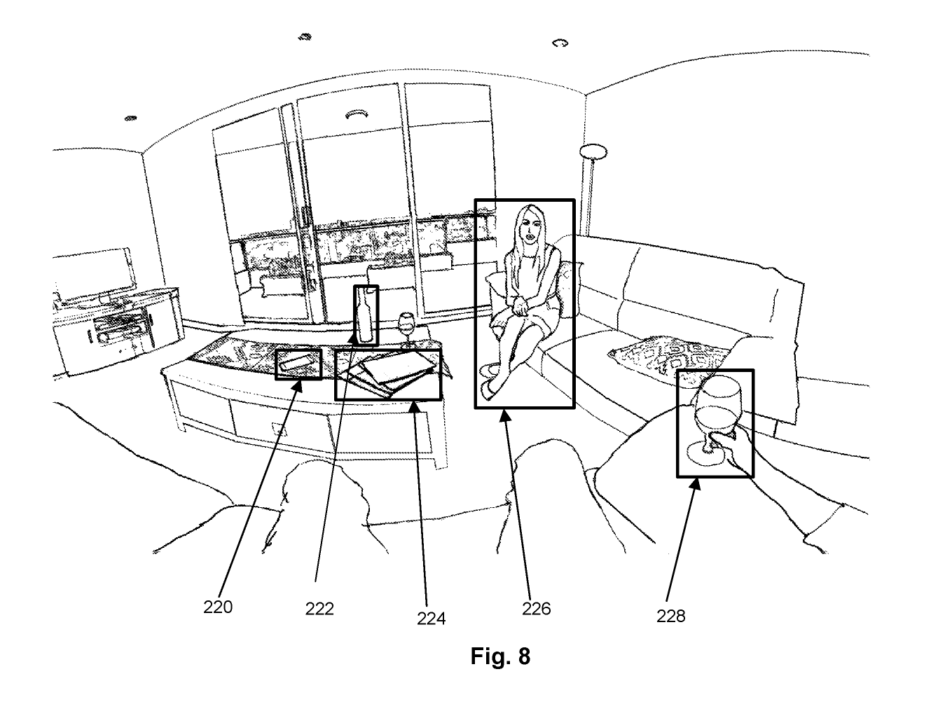

FIG. 8 illustrates a drawing of a single-eye view of a frame for a virtual reality video with IPP markers. Markers 220-228 for IPP objects in a VRV can be placed in a 3D location corresponding to the IPP objects in any given frame of the VRV. The markers 220-228 are generated for the IPP objects in each scene and can be placed at the locations of the objects, acting as a bounding box around the objects. These markers 220-228 are generated and placed on a per frame basis, as the camera location and the object location can change on per frame basis, as reflected in the per frame object mask data.

The markers 220-228 can be hidden from the user until time when the user gazes in the VRV frame within a marker's boundary. To know if a user is looking at the marker or not, an intersection detection can run between the vector of the user's gaze and the bounding box for the marker. A standard vector to bounding box clipping algorithm in 3D graphics can be used, and can run in real-time as the user's gaze shifts over the frame. As the user is free to look anywhere they want in the VRV, only when he/she looks at the marker will the marker be displayed. Alternatively, the markers 220-228 can be set to be all visible by default or by selection of the user to view what IPPs are present in the frame of the VRV.

As an alternative to identifying the VRV through a color mask, it can be identified as a region of interest with a varying-sized bounding box sent with the video stream. The bounding box can carry a unique VRV ID to identify itself. The bounding box can be further animated by sending motion vectors that describe the motion of that bounding box throughout the portion of the video where that VRV is active. A separate bounding box can be specified for the left eye and the right eye to give the bounding box a position in a Z-direction, similar to the Z-depth disparity of the previous method.

In another variation of the bounding box, rather than having separate bounding boxes for the left eye and the right eye, one can just have a single bounding box and optionally send an animating left eye and right eye disparity value. This disparity value can be animated as the VRV moves closer and further from the camera. It can be appreciated that other variations for identifying interactive objects within the VRV can be envisioned using the methods of the present disclosure. Such obvious variations based on the present disclosure are meant to be included in the scope of the present disclosure.

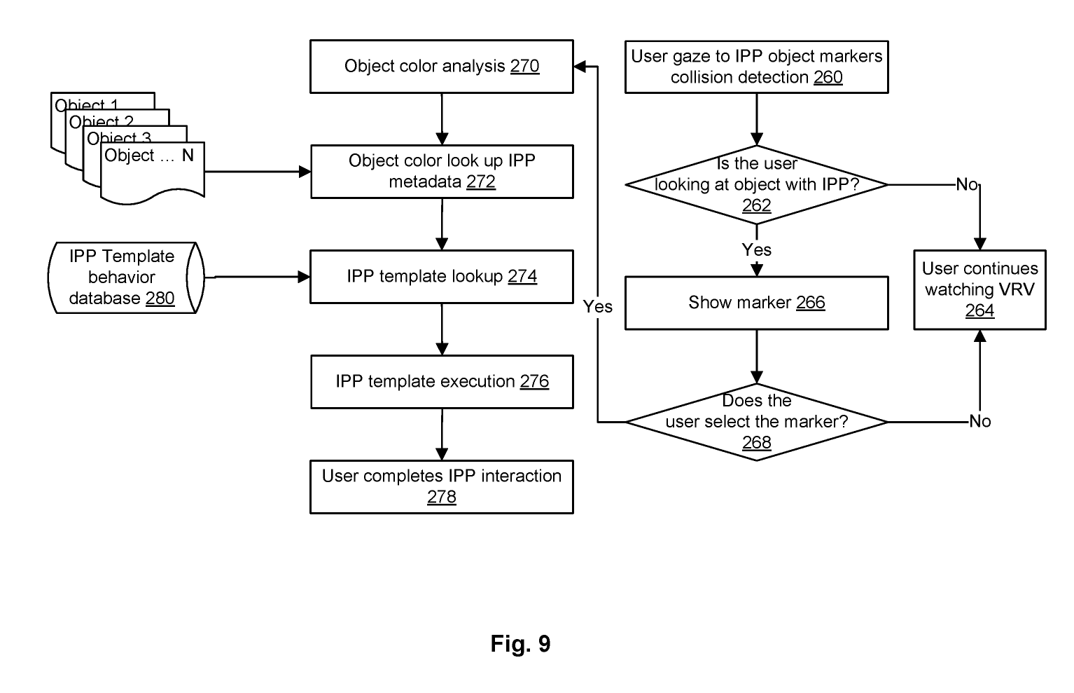

FIG. 9 illustrates a process flow diagram of the present disclosure for user interaction with IPP. A collision detection between a user's gaze and an IPP object marker is determined, step 260. If the user is looking at an object with IPP, step 262, a marker is shown, step 266. If not, the user is allowed to continue watching the VRV 264. Next, it's determined if the user selects the marker 268. If the user selects the marker, an object color analysis is performed, step 270. If the user does not select the marker, then the user is allowed to continue watching the VRV, step 264.

To interact with the IPP, the user must select the marker. At which point the object's ID within the marker will be sampled to find the correct IPP metadata. The sampling of the marker's object ID can take several forms. Generally, the object color is looked up in the IPP metadata for the object, step 272. Based on the IPP metadata, the IPP template lookup can be determined, step 274, by searching the type of template behavior in the IPP template behavior database 280, which can be located in the cloud via a network or locally. Next, the IPP template is executed, step 276. The user can then complete the IPP interaction, step 278.

Specifically, in one variation for sampling the marker's object ID, a process can start by determining where the user's gaze vector intersects a VRV dome. The VRV dome can be a surface that the video is projected onto. The dome's texture color is sampled at the point of intersection to be used to look up the correlating object ID in the IPP metadata.

A second variation for sampling the marker's object ID is when the marker's object ID is already stored as a part of the marker's data from the marker generation process. The object ID can be looked up once the marker is selected. Other variations can be implemented as well based on the present disclosure. Both of the disclosed methods can lead to the correct IPP metadata.

Once the IPP metadata is found, the corresponding template interactions can be looked up, step 274, and loaded from an IPP template database for execution, step 276. It can then be up to the user's VRV application to implement the interaction, such as displaying product info, a purchase funnel, and/or a separate VR experience in itself.

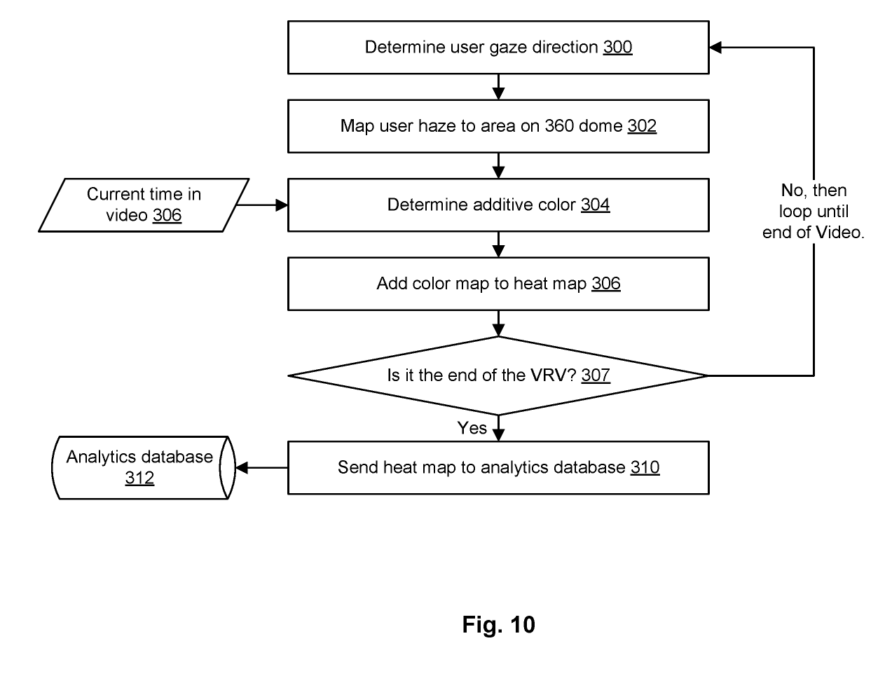

FIG. 10 illustrates a process flow diagram of the present disclosure for generating a user gaze based heat map. A parallel analytics process runs alongside the user's viewing of the VRV and his/her interaction with the IPP. A client side process can be performed to capture the viewing analytics of the user as a heat map. The purpose of this process is to capture where the user is looking and when to better indicate what has successfully captured his/her attention and what has not.

When a VRV is playing, a user's gaze direction is captured, step 300. The gaze direction can be used to project a blotch of color into the video texture space, step 302. The color of this blotch can be determined by two factors, step 304. One factor is a predetermined hit color, which can be red. The other factor is the normalized time factor into the video with “0” being the beginning of the video and “1” being the end. The current time in the video 306 can be inputted during the determination of the additive color in step 304. The time value of 0 maps to the color green, while the time value of 1 maps to the color blue. All other times in between is a direct linear interpolation of those two values. The resultant two factors are added to produce the final color of the blotch, which goes from yellow (e.g., red plus green) at the start of the video to brown (e.g., red plus half green and half blue) in the middle of the video to purple (e.g., red plus blue) at the end of the video.

This color blotch is then added to all previous color blotches in the VRV at a preconfigured time interval, step 307. For instance, one can generate a color blotch every 100 milliseconds, or 10 times per second. All these color blotches can be treated as additive, so that the color values will add to each other, with the color getting darker with each addition.

Next, it's determined if the end of video has been reached, step 308. If not, then the loop continues with determining the user gaze direction in step 300. If the end of the video is reached, then the heat map is sent, step 310, to an analytics database 312 for usage.

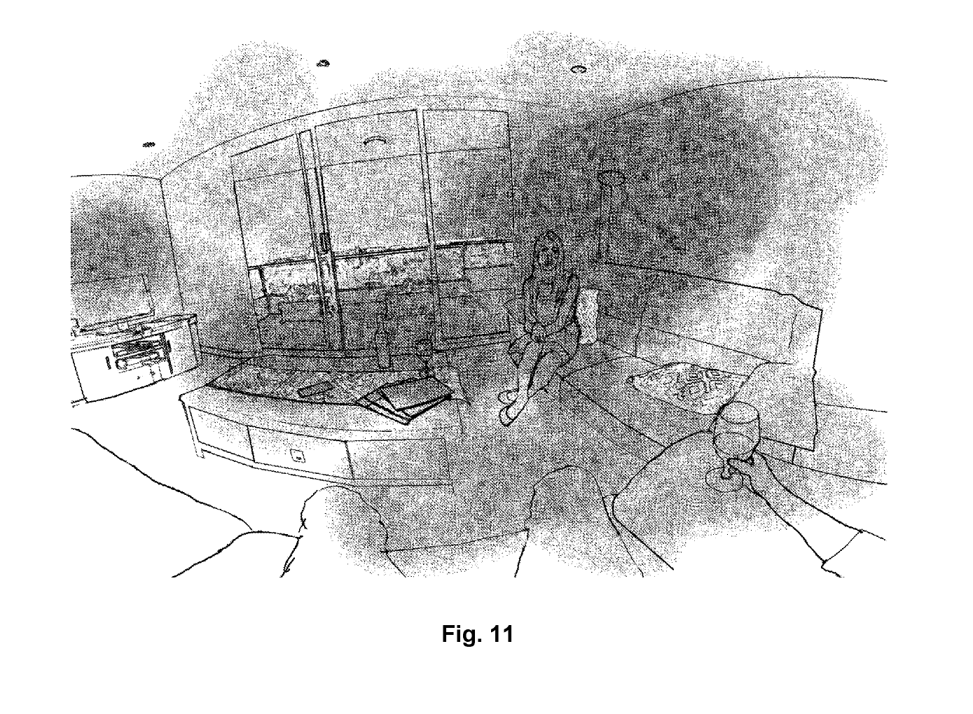

FIG. 11 illustrates a drawing of a heat map. Once the color blotches are aggregated, then certain areas will have higher shading (or more reddish coloring) than other areas in the frame.

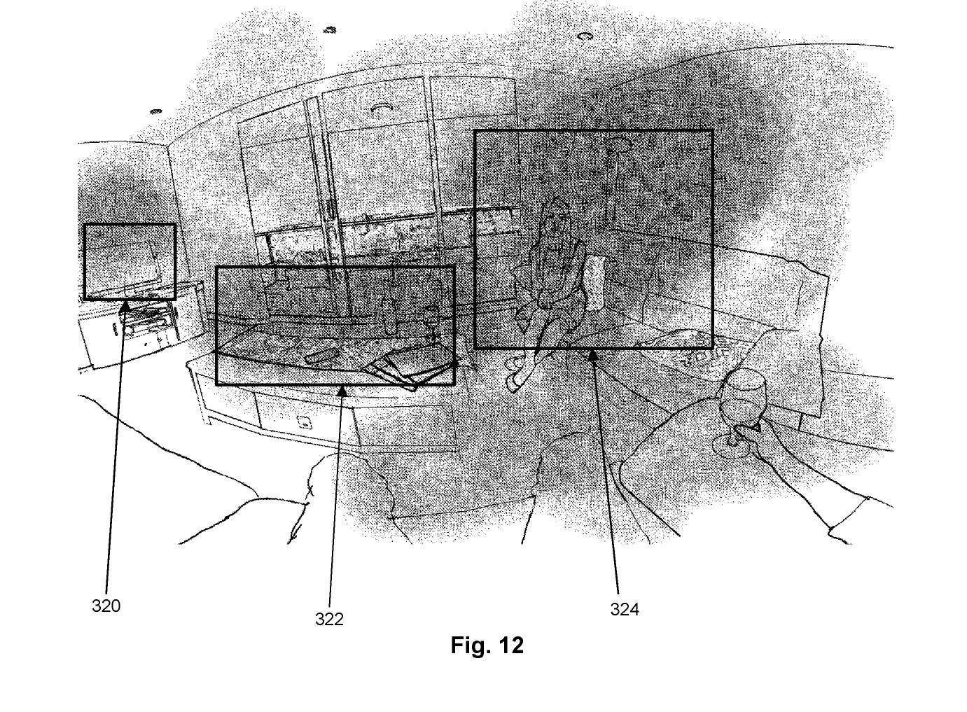

FIG. 12 illustrates a drawing of a heat map with key areas of interest called out. At an end of a VRV viewing experience, the heat map can be sent to a server for further heat map analysis. On the server side, single or multiple heat maps can be aggregated to determine viewing trends. The heat map can have regions of interest 320, 322 and 324 based on heat map density as regions with a high, medium, and low density threshold, respectively. One can use a density threshold to gauge if a region is of interest or not.

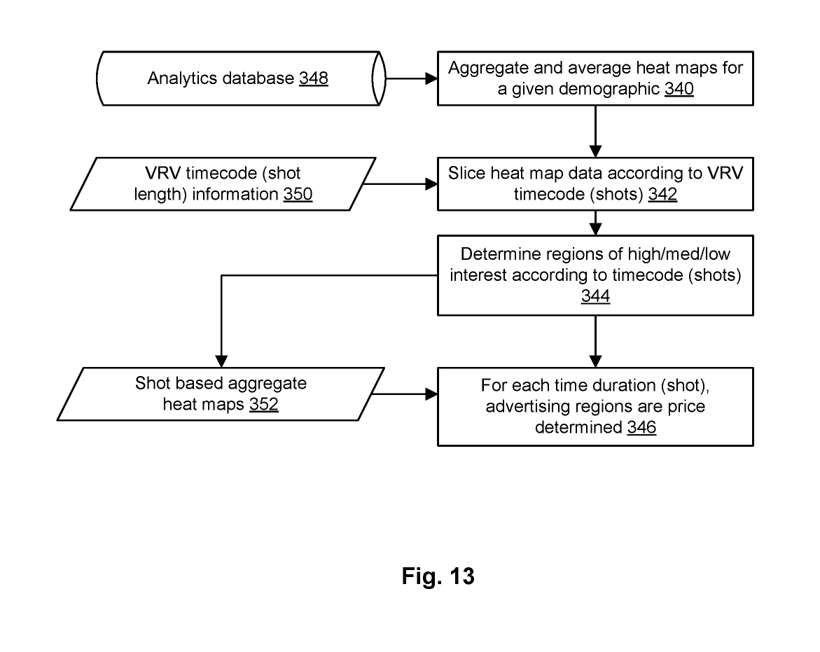

FIG. 13 illustrates a process flow diagram of the present disclosure for aggregating and analyzing a heat map. Heat maps can be analyzed to provide accurate shot-by-shot information on where a user is looking and at what time. First, a set of heat maps (stored in the analytics database 348) are aggregated by a set of demographic information, such as location, age, gender, and any other user metadata that the VRV system can provide. This aggregate data then can be averaged (or weighed) to provide the aggregate info across that demographic, step 340. The normalized time data (e.g., green and blue colors) can be converted to shot based time data, step 342, and be filtered accordingly. The heat map data can be sliced, step 342, according to the VRV timecode provided by the VRV timecode information 350.

Furthermore, regions of high, medium, and low interest in accordance with a timecode (or shots) can be determined for use for shot base aggregation of heat maps, step 344. For each shot duration, the shot based aggregate heat maps 352 and the regions of interest can be used to determine advertising regions for price determination, step 346.

For a given shot that occupies the last 10% of the frame range of the film, a color filter can be applied to remove all color blotches that have more than 10% green and less than 10% blue in the heat map for that VRV. The resultant heat map will show where the aggregated user demographic was looking for the last shot of the VRV.

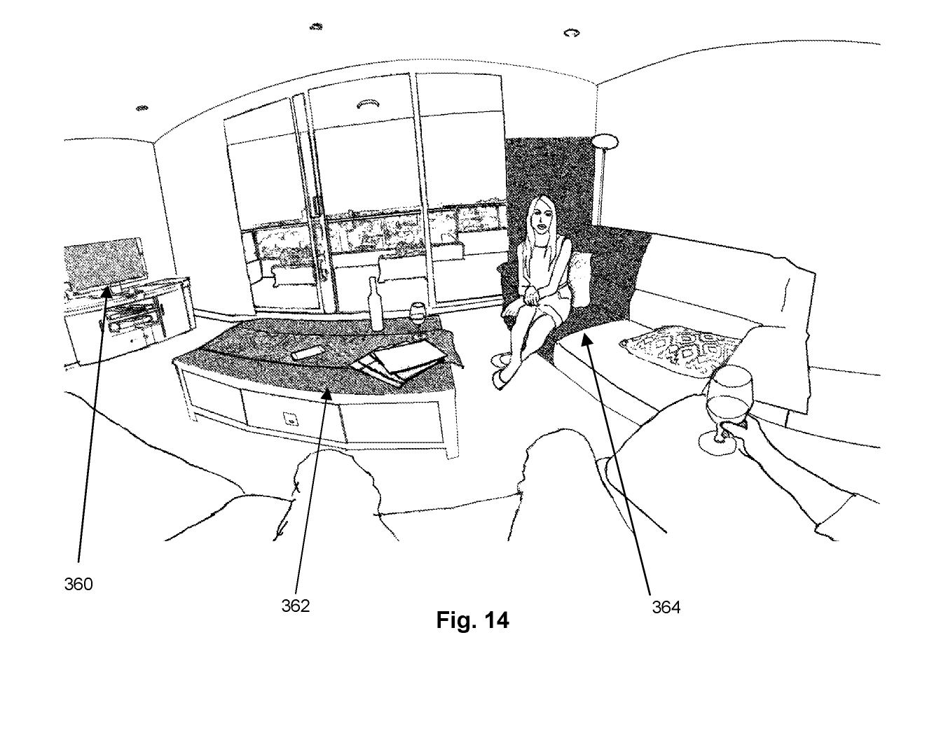

FIG. 14 illustrates a drawing of a result of a heat map analysis. A filtered heat map can be converted to relevant information for the IPP content generator, e.g., be interpreted for advertising purposes. The heat map concentration areas 360, 362, and 364 can be translated to high, medium, or low advertising areas. Based on the heat map analytics, the user spends most of the time looking around the region 364 in which a woman is located. Thus, the couch area which overlaps with the region 364 that she is sitting on and the wall behind can be identified as a high valued advertising area. Furthermore, the coffee table surface in region 362 can have the second highest frequency of view, making it a medium valued advertising area. Lastly, the television screen in the left part of the shot in region 360 has a low frequency of view, making it a low valued advertising area.

IPP content generators can take this analytics data to inform themselves where to further place their interactive content to maximize efficacy. They can employ visual effects post processing methods to move existing or place new IPP objects in the VRV and iterate new analytics data to further refine their use, which initiates the various flow diagrams of the present disclosure.

While the disclosure has been described with reference to certain embodiments, it is to be understood that the disclosure is not limited to such embodiments. Rather, the disclosure should be understood and construed in its broadest meaning, as reflected by the following claims. Thus, these claims are to be understood as incorporating not only the apparatuses, methods, and systems described herein, but all those other and further alterations and modifications as would be apparent to those of ordinary skill in the art.

We claim:

1. A method for processing a virtual reality video (“VRV”) by a virtual reality (“VR”) computing device, comprising the steps of:
identifying objects for embedding in the VRV;
generating interactive objects for the VRV, wherein the generated interactive objects have metadata for defining interactions with users;
embedding the VRV with the generated interactive objects by the VR computing device; and
storing the embedded VRV in a data storage by the VR computing device.

2. The method of claim 1 wherein the generated interactive objects are three dimensional viewable objects within the embedded VRV.

3. The method of claim 1 wherein, in the identifying step, the identified objects are existing viewable objects in the VRV.

4. The method of claim 1 wherein, in the embedding stage, the identified objects and the metadata are packaged for delivery in the embedded VRV to a VR player.

5. The method of claim 1 further comprising the step, after the storing step, of playing the embedded VRV from the data storage by a VR player, wherein the interactive objects of the embedded VRV are selectable by the VR player for interaction by a user of the VR player.

6. The method of claim 1 wherein heat maps are generated for the VRV based on gaze directions of users and wherein identified objects are selected based on the heat maps.

7. The method of claim 6 wherein the heat maps are aggregated, and wherein the aggregated heat maps are used to identify locations of interest for placement of the identified interactive objects.

8. The method of claim 7 wherein the identified objects are artificially placed in the VRV based on content of the VRV and based on the identified locations of interest.

9. The method of claim 6 wherein the locations of interest are assigned interest levels and wherein an advertising price determination for the locations of interest are based on the assigned interest levels.

10. The method of claim 6 wherein the locations of interest are assigned interest levels based on user gaze densities for the VRV.

11. A virtual reality (“VR”) computing device for processing a virtual reality video (“VRV”), comprising:
an object identification module for identifying objects to embed in the VRV;
an interactive object generation module for generating interactive objects for the VRV;
an embedding module for embedding the VRV with the generated interactive objects; and
a data storage module for storing the embedded VRV.

12. The computing device of claim 11 wherein the generated interactive objects are three dimensional viewable objects within the embedded VRV.

13. The computing device of claim 11 wherein the identified objects are existing viewable objects in the VRV.

14. The computing device of claim 11 wherein, in the generating step, the identified objects are associated with interaction metadata and wherein, in the embedding stage, the identified objects and metadata are packaged for delivery in the embedded VRV to a VR player.

15. The computing device of claim 11 wherein heat maps are generated for the VRV based on gaze directions of users and wherein identified objects are selected based on the heat maps.

16. The computing device of claim 15 wherein the heat maps are aggregated, and wherein the aggregated heat maps are used to identify locations of interest for placement of the identified interactive objects.

17. The computing device of claim 16 wherein the identified objects are artificially placed in the VRV based on content of the VRV and based on the identified locations of interest.

18. The computing device of claim 16 wherein the locations of interest are assigned interest levels and wherein an advertising price determination for the locations of interest are based on the assigned interest levels.

19. The computing device of claim 16 wherein the locations of interest are assigned interest levels based on user gaze densities for the VRV.

20. A method for processing a virtual reality video (“VRV”) by a virtual reality (“VR”) computing device, comprising the steps of:
identifying objects for embedding in the VRV for interactive product placement (“IPP”), wherein the identified objects are existing viewable objects in the VRV;
generating interactive objects for the VRV, wherein the identified objects are associated with interaction metadata;
embedding the VRV with the generated interactive objects by the VR computing device,
wherein the identified objects and metadata are packaged for delivery in the embedded VRV to a VR player; and
storing the embedded VRV in a data storage by the VR computing device,
wherein the generated interactive objects are three dimensional viewable objects within the embedded VRV,
wherein heat maps are generated for the VRV based on gaze directions of users,
wherein the heat maps are aggregated,
wherein the aggregated heat maps are used to identify locations of interest for placement of the identified interactive objects,
wherein the locations of interest are assigned interest levels, and
wherein an advertising price determination for the locations of interest are based on the assigned interest levels.
